(19) United States
(12) Patent Application Publication
(10) Pub. No.: US 2019/0015687 A1
(43) Pub. Date: Jan. 17, 2019

(54) CLIMB ASSIST AND FALL ARREST SYSTEM

(71) Applicant: Safeworks, LLC, Tukwila, WA (US)

(72) Inventor: Morgan Knickrehm, Kalispell, MT (US)

(21) Appl. No.: 16/037,793

(22) Filed: Jul. 17, 2018

Related U.S. Application Data
(60) Provisional application No. 62/533,600, filed on Jul. 17, 2017.

(51) Int. Cl. A62B 1/10; A62B 1/14

(52) U.S. Cl. CPC A62B 1/10; A62B 35/0043; A62B 1/14

(57) ABSTRACT

A climb assist and fall arrest system is disclosed that includes fall arrest components in connection with climb assist components. The connection of the fall arrest components and the climb assist components may include physical connection, electronic connection, communication, or any combination thereof. Communication between the fall arrest components and the climb assist components may include information being passed from one of the fall arrest components and the climb assist components to the other of the fall arrest components and the climb assist components. The climb assist and fall arrest device may be configured to transition from a disengaged configuration to an engaged configuration based on the information passed between the fall arrest components and the climb assist components.

### CROSS-REFERENCE

This application claims benefit under 35 U.S.C. § 119(e) of Provisional U.S. patent application No. 62/533,600, filed Jul. 17, 2017, the contents of which are incorporated herein by reference in their entirety.

### TECHNICAL FIELD

The present disclosure relates generally to systems, devices, and methods configured to assist an individual climbing or descending. More specifically, the present disclosure relates to systems, devices, and methods configured both to assist a climber on a climbing apparatus by supporting a portion of the climber's weight during ascent and descent on the ladder, and to arrest the downward movement of the climber in the event of fall from the structure.

### BACKGROUND

Climb assist devices are known, such as U.S. Pat. No. 8,141,681. Additionally, fall arrest devices are known, such as U.S. Pat. No. 6,837,337. Typically, climb assist and fall arrest devices are two separate devices that operate independently of one another. If a fall occurs and the fall arrest device activates, locking the climber in place, continued operation of the climb assist may lead to potential minor injury for the climber.

### BRIEF DESCRIPTION OF THE DRAWINGS

The foregoing summary, as well as the following detailed description of illustrative embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIG. 1 is a side elevation view of a climb assist and fall arrest system according to one aspect of the disclosure;

FIG. 2 is a top plan view of a first layer of a climb assist and fall arrest device of the climb assist and fall arrest system illustrated in FIG. 1, according to one aspect of the disclosure;

FIG. 3 is a top plan view of a second layer of the climb assist and fall arrest device illustrated in FIG. 2;

FIG. 4 is a top plan view of a third layer of the climb assist and fall arrest device illustrated in FIG. 2; and

FIG. 5 is a logic flow diagram of the climb assist and fall arrest device illustrated in FIG. 2, according to one aspect of the disclosure.

### DETAILED DESCRIPTION OF ILLUSTRATIVE EMBODIMENTS

The embodiments disclosed herein are not limited in application to the details of construction and the arrangement of components set forth in the following description or illustrated in the drawings. The disclosure is capable of other embodiments and of being practiced or being carried out in various ways. In addition, the phraseology and terminology used herein is for the purpose of description and should not be regarded as limiting.

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure. Certain features of the disclosure, which are described herein in the context of separate embodiments, may also be provided in combination in a single embodiment. Conversely, various features of the disclosure that are described in the context of a single embodiment may also be provided separately or in any subcombination.

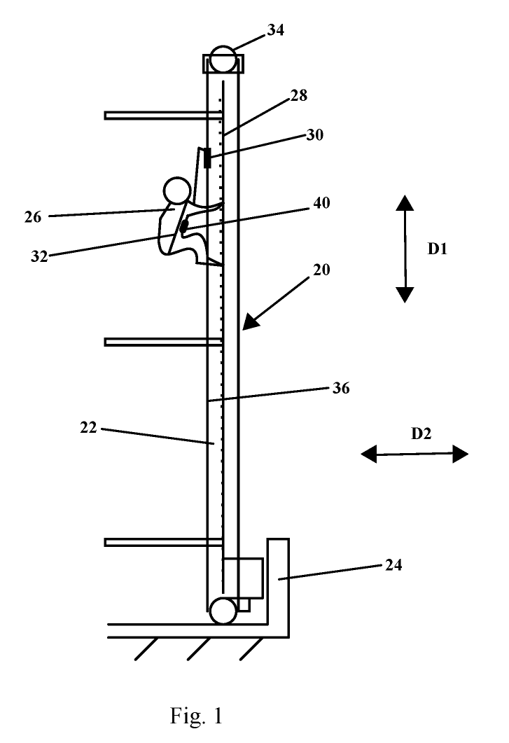

Referring to FIG. 1, a climb assist and fall arrest system 20 may include a structure 22 configured to be positioned on a base surface 24 and then climbed up to increase elevation of the user 26 relative to the base surface 24 and climbed down to decrease elevation of the user 26 elevation relative to the base surface 24. According to one aspect of the disclosure, the structure 22 may include a ladder, and the base surface 24 may include a portion of the ground, a wall, a floor, or other surface suitable to support the structure 22.

The climb assist and fall arrest system 20 may further include a track 28 supported by, for example, the structure 22. The track 28 is configured to receive a follower 30 such that the follower 30 is both movable with respect to the track 28 along a first direction D1 and restricted from moving with respect to the track 28 along a second direction D2. As shown in the illustrated embodiment, the first direction D1 may include the both the directions of ascent and descent of the structure 22 and the second direction D2 may be perpendicular to the first direction D1. According to one aspect of the disclosure, the track 28 may include a cable, a rail, a channel, or any combination thereof

The climb assist and fall arrest system 20 may further include a harness 32 configured to be secured to, for example worn by, the user 26. The harness 32 is further configured to be attached to the follower 30 such that movement of the user 26 along the first direction D1, results in movement of the follower 30 along the track 28 along the first direction D1.

The climb assist and fall arrest system 20 may further include a support assembly 34 configured to support at least a portion of the weight of the user 26 during movement of the user 26 in the first direction D1 along the structure 22. The support assembly 34 may include a belt, cable, rope, or other support member 36. According to one embodiment, the support member 36 forms a continuous loop. According to another embodiment, the support member 36 includes a first end that is configured to attach to the user 26, for example via the harness 32, and a second end configured to attach to a motor, one or more pulleys, counterweights, or any combination thereof The support assembly 34 may further include an attachment grab, for example a cam or a lever, configured to attach to the support member 36.

The climb assist and fall arrest system 20 may further include a climb assist and fall arrest device 40 configured to couple the user 26 to the structure 22 and assist ascent and descent of the structure 22 by the user 26. The climb assist and fall arrest device 40 is configured both to support at least a portion of the weight of the user 26 during ascent of the structure 22, and to arrest movement of the user 26 relative to the structure 22 when the user 26 is falling.

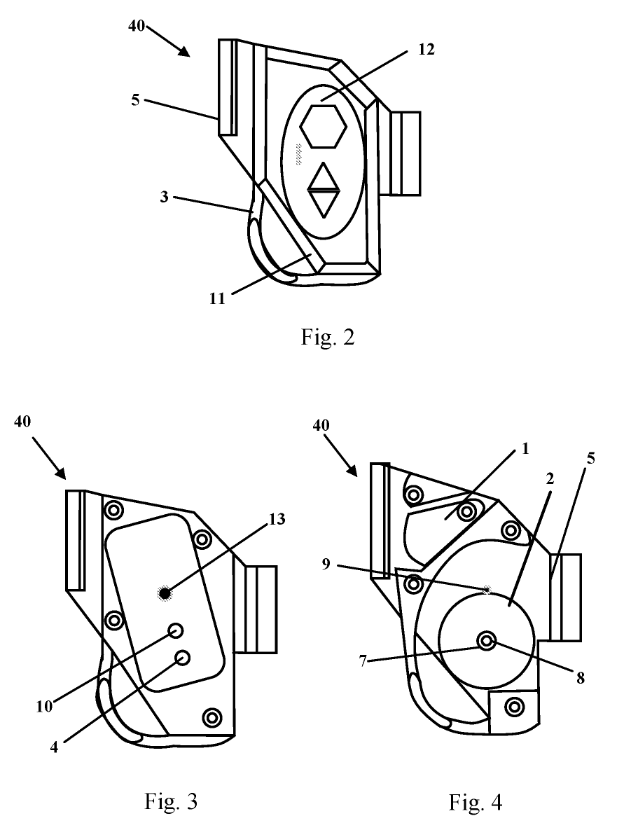

Referring to FIGS. 2 to 4, according to one aspect of the disclosure, the climb assist and fall arrest device 40 includes a sensor 10 configured to detect a first parameter of the climb assist and fall arrest device 40. The first parameter may include speed, acceleration, or both. The climb assist and fall arrest device 40 further includes a brake mechanism 8, and the climb assist and fall arrest device 40 defines a disengaged configuration and an engaged configuration. In the disengaged configuration the climb assist and fall arrest device 40 is freely movable relative to the track 28 along the first direction D1. In the engaged configuration the climb assist and fall arrest device 40 is not freely movable relative to the track 28 along the first direction D1. According to one embodiment, in the engaged configuration relative movement of the climb assist and fall arrest device 40 and the track 28 is completely prevented. According to another embodiment, in the engaged configuration relative movement of the climb assist and fall arrest device 40 and the track 28 is restricted to a speed slow enough to prevent major injury to the user 26 upon reaching the base surface 24. According to another embodiment, in the engaged configuration relative movement of the climb assist and fall arrest device 40 and the track 28 is restricted to an acceleration below that of a free fall, for example zero meters per second squared.

The climb assist and fall arrest device 40 includes fall arrest components that are configured to arrest a fall of the user 26 in communication with climb assist components of the climb assist and fall arrest device 40 that are configured to support at least a portion of the weight of the user 26. The communication of the fall arrest components and the climb assist components may include physical connection, electronic connection, or both. Physical connection between the fall arrest components and the climb assist components may include, but is not limited to, mechanical, magnetic, pneumatic, etc. Electronic connection between the fall arrest components and the climb assist components may include a system capable of passing information from one of the fall arrest components and the climb assist components to the other of the fall arrest components and the climb assist components such as but not limited to wired, wireless, fiber optic, or any combination thereof The electronic connection can include one-way or two-way communication between the fall arrest components and the climb assist components. The information passed between the fall arrest components and the climb assist components may include one or more of the status, velocity, acceleration, load, position, orientation, of components of the climb assist and fall arrest system 20. The climb assist and fall arrest system 20 may include or may be configured to be connected to a supervisory control and data acquisition (SCADA) system configured to record, report, or both data and events associated with the climb assist and fall arrest system 20.

The climb assist and fall arrest device 40 may be configured to transition from one of the engaged configuration and the disengaged configuration to the other of the engaged configuration and the disengaged configuration based on the information passed between the fall arrest components and the climb assist components. For example, the status of one or more of the climb assist components may be changed, for example the motor may be toggled from on to off, in response to the climb assist and fall arrest device 40 transitioning from the disengaged configuration to the engaged configuration, or vice versa.

A climb assist and fall arrest device 40 including fall arrest components connected to climb assist components as described above may provide benefits including: controlled interaction between the fall arrest components and the climb assist components; access of the fall arrest components to additional data including, but not limited to, acceleration, speed, jerk, climb assist force, user input, or any combination thereof, and the capability for the fall arrest components to use any of that data as a trigger to transition the climb assist and fall arrest device 40 from the disengaged configuration to the engaged configuration; access of the climb assist components to additional data including whether the climb assist and fall arrest device 40 is in the engaged configuration, and if the climb assist and fall arrest device 40 is in the engaged configuration to turn off one or more of the climb assist components; the climb assist and fall arrest device 40 may include a lockout preventing operation of the climb assist components prior to connection of the fall arrest components to the track 28, thus reducing the risk of the user 26 forgetting to attach the fall arrest components to the track 28; data collection including, but not limited to, distance traveled, on time for various components of the climb assist and fall arrest device 40, number of times the climb assist and fall arrest device 40 transitions from the disengaged configuration to the engaged configuration, etc., improving efficiencies related to service and maintenance of the climb assist and fall arrest system 20; internal storage for data collected by the climb assist and fall arrest system 20, generated by the climb assist and fall arrest system 20, or both; capability to report when the climb assist and fall arrest device 40 transitions from the disengaged configuration to the engaged configuration alerting others that the user 26 may be in need of assistance; reduced fall distance prior to transition of the climb assist and fall arrest device 40 from the disengaged configuration to the engaged configuration; or any combination thereof.

Referring to FIG. 1, some known fall arrest devices require a user to fall between about 12 to about 20 inches. This fall distance is a result of the known fall arrest device hanging from a harness a certain distance. In the event of a fall, the member connecting the fall arrest device to a track on the structure will go taut prior to the fall arrest device engaging with the track and arresting the fall. According to one aspect of the disclosure, the climb assist components of the climb assist and fall arrest device 40 are configured to keep the member connecting the climb assist and fall arrest device 40 to the track 30 taut, thereby minimizing fall distance prior to transitioning the climb assist and fall arrest device 40 from the disengaged configuration to the engaged configuration.

According to one embodiment, the climb assist and fall arrest device 40 is configured such that the user 26 falls less than 12 inches prior to the climb assist and fall arrest device 40 transitioning from the disengaged configuration to the engaged configuration, thereby stopping movement of the user 26 relative to the structure 12 in the first direction D1. According to another embodiment, the climb assist and fall arrest device 40 is configured such that the user 26 falls less than 6 inches prior to the climb assist and fall arrest device 40 transitioning from the disengaged configuration to the engaged configuration, thereby stopping movement of the user 26 relative to the structure 12 in the first direction D1. According to another embodiment, the climb assist and fall arrest device 40 is configured such that the user 26 falls between about 2 inches and about 3 inches prior to the climb assist and fall arrest device 40 transitioning from the disengaged configuration to the engaged configuration, thereby stopping movement of the user 26 relative to the structure 12 in the first direction D1.

Referring again to FIGS. 2 to 4, according to one aspect of the disclosure, the climb assist components and the fall arrest components may be mechanically connected. For example, the climb assist and fall arrest device 40 may include a yoke connecting or tying the climb assist components and the fall arrest components to one another. Additionally, or alternatively, the climb assist components and the fall arrest components may be mounted to or housed at least partially within a common structure, such as a housing 5 that is configured to be attached to the harness 32.

As shown in the illustrated embodiment, the climb assist and fall arrest device 40, may include a climb assist connector 1, which connects the climb assist and fall arrest device 40 to the support member 36. The support member 36 may include metal, polymer, rope, or any combination thereof. The climb assist connector 1 may include a camming member configured to engage the support member 36 with the climb assist and fall arrest device 40, for example with the housing 5.

As shown in the illustrated embodiment, the climb assist and fall arrest device 40, may include a fall arrester 2. The fall arrester is configured to engage the track 28. According to one embodiment, the fall arrester 2 includes a wheel that upon reaching a designated speed of rotation, locks, engages, or both with the brake mechanism 8 to halt downward motion of the climb assist and fall arrest device 40, and the attached user 26. The fall arrester 2 may be configured to engage with the brake mechanism in response to only movement of the climb assist and fall arrest device 40 toward the base surface 24.

As shown in the illustrated embodiment, the climb assist and fall arrest device 40, may include a load sensor 3 configured to measure a load applied by the support assembly 34, for example the motor, to the climb assist and fall arrest device 40. The load sensor 3 may be positioned within the housing 5, or may be separate from the housing 5.

As shown in the illustrated embodiment, the climb assist and fall arrest device 40, may include a processor and sending unit 4. The processor and sending unit 4 may include a printed circuit board assembly that converts sensor data, for example from the load sensor 3, into a digital signal and then sends the digital signal, for example wirelessly, to the support assembly.

The housing 5 of the climb assist and fall arrest device 40 may include metallic material, polymeric material, or both. The housing 5 may be rigid cast, formed, forged, machined, injection molded, 3D printed, any combination thereof, or the housing 5 may be made through other known manufacturing methods.

As shown in the illustrated embodiment, the climb assist and fall arrest device 40, may include a cable presence sensor 6. The cable presence sensor 6 is configured to detect the presence of the follower 30, for example a fall arrest cable, coupled or configured to be coupled to the track 28. The cable presence sensor 6 may include an optical, resistance, inductive, laser, capacitive, eddy current, ultrasonic, or similar sensor configured to detect the presence of follower 30.

As shown in the illustrated embodiment, the climb assist and fall arrest device 40, may include a speed sensor 7 configured to directly, indirectly, or both measure velocity of the track 28 relative to the climb assist and fall arrest device 40. The brake mechanism 8 of the climb assist and fall arrest device 40 may include an electro-mechanical brake configured to be engaged by the processor and sending unit 4. The brake mechanism 8 may include a solenoid configured to transition the climb assist and fall arrest device 40 from the disengaged configuration to the engaged configuration. The climb assist and fall arrest device 40 may further include a brake engagement sensor 9 configured to detect whether the climb assist and fall arrest device 40 is in the engaged configuration or the disengaged configuration.

As shown in the illustrated embodiment, the climb assist and fall arrest device 40, for example the sensor 10, may include an accelerometer configured to measure acceleration of the climb assist and fall arrest device 40. The housing 5 may include a cover 11, for example a removable cover 11 that encloses other components of the climb assist and fall arrest device 40 within the housing 5. The cover 11 may include the same materials as the housing 5 or different materials than the housing 5.

As shown in the illustrated embodiment, the climb assist and fall arrest device 40, may include one or more input mechanisms 12. The one or more input mechanism 12, for example buttons, are configured to receive input from the user 26, for example the user 26 pushing a button with a finger, to adjust performance of the climb assist and fall arrest device 40. For example, the one or more input mechanisms 12 may include up and down buttons configured to be pushed by the user 26 to indicate whether the user 26 is going up the structure 22 or down the structure 22, and thereby engaging the motor to move in the appropriate direction. The one or more input mechanisms 12 may include a stop button configured to send a signal to the motor to stop moving when the stop button is pressed.

As shown in the illustrated embodiment, the climb assist and fall arrest device 40, may include a speaker 13. The speaker 13 is configured to emit an audible signal, for example, an alarm to indicate that the climb assist and fall arrest device 40 has transitioned from the disengaged configuration to the engaged configuration, and to alert others that the user 26 may require assistance.

The climb assist and fall arrest device 40 may include one or more lockouts configured to prevent accidental disconnection of the climb assist and fall arrest device 40 from the track 28. According to one embodiment, the lockout may be configured to require two distinct actions to remove the climb assist and fall arrest device 40 from engagement with the track 28. The climb assist and fall arrest device 40 may include mechanical lockouts, electrical lockouts, or both that prevent incorrect connection such as connecting a fall arrest cable to the climb assist belt or connecting the climb assist and fall arrest device 40 upside down. The climb assist and fall arrest device 40 may be configured such that in the event of a failure of any electronic or electrical components of the climb assist and fall arrest device 40, or if the climb assist components are not engaged with any support assembly 34, or if any of the climb assist components are damaged, the climb assist and fall arrest device 40 continues to operate as a fall arrester, or is still capable of transitioning from the disengaged configuration to the engaged configuration without any additional input or information from the climb assist components.

According to one aspect of the disclosure, when the climb assist and fall arrest device 40 is not providing any climb assistance, or is not supporting any of the weight of the user 26, the climb assist and fall arrest device 40 may be configured to provide enough friction to hold itself up when the user 26 is climbing down toward the base surface 24, thereby decreasing fall distance needed for the climb assist and fall arrest device 40 to transition from the disengaged configuration to the engaged configuration. The climb assist and fall arrest device 40 may be configured to exert a first friction force while the user 26 is ascending the structure 22, and a second friction force different from the first friction force when the user 26 is descending the structure 22.

According to one aspect of the disclosure, the climb assist and fall arrest device 40 may be configured such that connection of the climb assist and fall arrest device 40 to the track 28 without a successful test of the climb assist and fall arrest device 40 being performed is prevented. The climb assist and fall arrest device 40 may further be configured such that in the event of a failed test the climb assist and fall arrest device 40 includes a lockout configured to be overridden using a mechanical intervention, such as removal of the cover 11 and turning a knob or lever, or using a key.

The brake mechanism 8 may include a small wheel that drives the fall arrest wheel and is positioned at least partially outside the housing 5. The small wheel may be configured to be pressed against the support member 36 as the user 26 moves at a safe speed to test that the bake mechanism 8 is calibrated and engaging at the correct speed.

The climb assist and fall arrest device 40 may include a test mode, where the brake mechanism is purposely engaged (for example by dropping the climb assist and fall arrest device 40 in freefall) and at least one of the velocity and acceleration are measured to verify the climb assist and fall arrest device 40 is functioning properly. The climb assist and fall arrest device 40 may be configured to prevent usage of the climb assist and fall arrest device 40 without a fall arrest test being performed. The climb assist and fall arrest device 40 may include an indicator light that indicates whether a fall arrest test has been performed. The climb assist and fall arrest device 40 may be configured such that the brake mechanism 8 is configured to be manually activated by the user 26, for example by squeezing an actuator of the climb assist and fall arrest device 40. The climb assist and fall arrest device 40 may include a prominent emergency stop button that engages the brake mechanism 8, transitioning the climb assist and fall arrest device 40 from the disengaged configuration to the engaged configuration, when pressed. The climb assist and fall arrest device 40 may include a rigid or semi-rigid member that connects the climb assist and fall arrest device 40 to the user 26, for example via the harness 32. The rigid or semi-rigid member may be configured to retain the climb assist and fall arrest device 40 closer to at least one of the user 26 and the track 28, thereby decreasing fall distance in the event of a fall, even if the support assembly 34 has not yet applied a load to the climb assist and fall arrest device 40.

The climb assist and fall arrest device 40 may be configured to lock out, or prevent any support of the weight of the user 26 when the climb assist and fall arrest device 40 is not connected to the track 28, when the climb assist and fall arrest device 40 is installed upside down, when the climb assist and fall arrest device 40 is in the engaged configuration, or any combination thereof. The climb assist and fall arrest device 40 may be configured to measure load supplied by the support assembly 34 to the user 26, and transmit that data to components of the support assembly 34. The climb assist and fall arrest device 40 may be configured to transmit an independent identification, for example to the support assembly 34.

The climb assist and fall arrest device 40 may be configured to measure the velocity of the user 26 via a sensor measuring the speed of the track 28 relative to the climb assist and fall arrest device 40. The climb assist and fall arrest device 40 is configured to transmit that data to components of the support assembly 34, such as the motor. The climb assist and fall arrest device 40 may include a battery, and the climb assist and fall arrest device 40 may be configured to charge the battery by rotation of components of the climb assist and fall arrest device 40, for example the wheel of the brake mechanism 8.

The climb assist and fall arrest device 40 may be configured such that upon the speed of the user 26 exceeding a set threshold, the climb assist and fall arrest device 40 sends a stop signal to the motor, thereby ceasing support of a portion of the weight of the user 26. The climb assist and fall arrest device 40 may further be configured such that if a stop signal has been sent to the motor, and the climb assist and fall arrest device 40 has not stopped moving for a selected amount of time, the brake mechanism 8 is engaged electronically, transitioning the climb assist and fall arrest device 40 from the disengaged configuration to the engaged configuration. The climb assist and fall arrest device 40 may be configured such that if the speed of the user 26 exceeds a selected maximum value, the brake mechanism 8 is engaged electronically, transitioning the climb assist and fall arrest device 40 from the disengaged configuration to the engaged configuration. The climb assist and fall arrest device 40 may be configured such that if the accelerometer senses the user 26 is falling, the device sends a stop signal to the motor.

The climb assist and fall arrest device 40 may include a mechanical lock configured to prevent overload of the load sensor 3, due to excessive motion of the climb assist and fall arrest device 40. The mechanical lock could be configured to allow a certain amount of displacement, then lock to prevent excessive displacement and sensor damage, but in the case of a hard fall, break away and deform in a way to absorb excess energy preventing injury to the user 26.

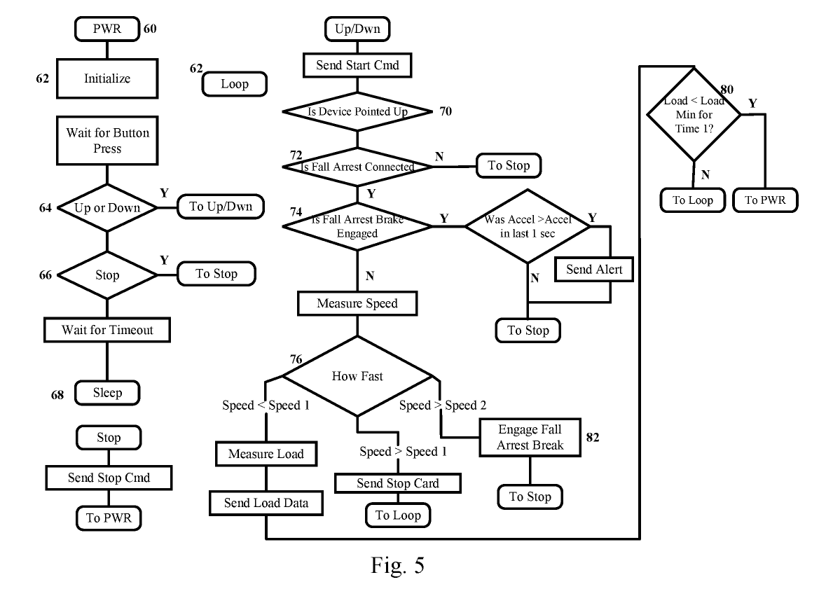

Referring to FIG. 5, when the climb assist and fall arrest device 40 is activated by the user 26, the climb assist and fall arrest device 40 is powered on at 60. The system initializes at 62 and awaits input from the user 26 such as a button press. Input to an Up or Down interface 64 sends a signal to the motor to support a least a portion of the weight of the user 26 and provide assistance in movement of the user 26 either up the structure 22 or down the structure 22 as indicated by the user 26. Input to a Stop interface 66 sends a signal to the motor to stop moving. Input to the Stop interface may further send a signal to power down the climb assist and fall arrest device 40. If the climb assist and fall arrest device 40 receives no input for a predetermined amount of time the system will enter a low-power sleep mode 68.

Input to the Up or Down interface 64 sends a start command to the motor. The climb assist and fall arrest device 40 detects either the climb assist and fall arrest device 40 being oriented upside down at 70, or detecting that the climb assist and fall arrest device 40 is not connected to the track 28 at 72, or detecting that the climb assist and fall arrest device 40 is in the engaged configuration at 74 sends a signal to the motor to stop moving.

The system measures the speed of the climb assist and fall arrest device 40 at 76. If the measured speed is less than a first selected speed the load is measured at 78. The load data may be sent or otherwise made available for further analysis. If the measured load is less than a first selected load at 80 for a minimum Time 1, than the system continues to run and provide support to the climber by returning to operation 70. If the measured load is greater than the first selected load at 80 for a Time 1, then operation may transition to operation 60.

If the measured speed is greater than the first selected speed, a signal is sent to stop the descent of the climber, such as causing the motor to stop. If the measured speed is greater than a second selected speed, then the climb assist and fall arrest device 40 is transitioned to the engage the fall arrest brake at 82. For example, a signal can be sent to activate the fall arrest brake or causing the motor to stop or slow down.

In some embodiments, the climb assist and fall arrest device 40 can be configured such that if the measured speed is greater than the first or second selected speeds, then the resulting action can be taken immediately. In some embodiments, the climb assist and fall arrest device 40 can be configured such that after the measured speed is greater than the first or second selected speeds for a predetermined period of time the resulting action is taken.

It will be appreciated that the foregoing description provides examples of the disclosed system. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein. All methods described herein can be performed in any suitable order unless otherwise indicated herein or otherwise clearly contradicted by context.

Although the disclosure has been described in detail, it should be understood that various changes, substitutions, and alterations can be made herein without departing from the spirit and scope of the invention as defined by the appended claims. Moreover, the scope of the present disclosure is not intended to be limited to the particular embodiments described in the specification. As one of ordinary skill in the art will readily appreciate from the disclosure of the present invention, processes, machines, manufacture, composition of matter, means, methods, or steps, presently existing or later to be developed that perform substantially the same function or achieve substantially the same result as the corresponding embodiments described herein may be utilized according to the present disclosure.

What is claimed:

1. A climb assist and fall arrest device comprising:
at least one fall arrest component configured to arrest a fall of a user of the climb assist and fall arrest device; and
at least one climb assist component configured to support at least a portion of the user's weight,
wherein the at least one fall arrest component is in communication with the at least one climb assist component such that: 1) the at least one climb assist component is configured to transition from a first state to a second state in response to information sent from the at least one fall arrest component to the at least one climb assist component; 2) the at least one fall arrest component is configured to transition from a third state to a fourth state in response to information sent from the at least one climb assist component to the at least one fall arrest component; or 3) both.

2. The climb assist and fall arrest device of claim 1, further comprising a housing at least partially enclosing both the at least one fall arrest component and the at least one climb assist component.

3. The climb assist and fall arrest device of claim 1, wherein the communication includes a physical connection, an electronic connection, or both.

4. The climb assist and fall arrest device of claim 1, wherein the mechanical connection includes a mechanical connection, and the electronic connection includes at least one of a wired connection, a wireless connection, and a fiber optic connection.

5. The climb assist and fall arrest device of claim 1, wherein the climb assist and fall arrest device is configured to be coupled to a support member such that: 1) the at least one fall arrest component applies a force to the support member to arrest a fall of the user and 2) the at least one climb assist component applies a force to the support member to support at least a portion of the weight of the user.

6. The climb assist and fall arrest device of claim 4, wherein the at least one climb assist component is configured such that the at least one climb assist component does not support at least a portion of the weight of the user until the at least one fall arrest component is coupled to the support member.

7. The climb assist and fall arrest device of claim 1, wherein in the first state the at least one climb assist component applies a lifting force to the user, and in the second state the climb assist does not apply any force to the user.

8. The climb assist and fall arrest device of claim 7, wherein in the third state the at least one fall arrest component does not apply any force to the user, and in the fourth state the at least one fall arrest component applies a force to the user.

9. The climb assist and fall arrest device of claim 8, wherein the force applied to the user by the at least one fall arrest component in the fourth state is sufficient to prevent movement of the user toward the ground.

10. The climb assist and fall arrest device of claim 1, further comprising a battery, wherein the at least one fall arrest component includes a rotatable member configured such that rotation of the rotatable member charges the battery.

11. The climb assist and fall arrest device of claim 1, wherein the at least one climb assist component is configured to be coupled to a motor, the at least one fall arrest component includes a sensor configured to detect data about the user, and the at least one climb assist component is configured to send a stop signal to the motor in response to the sensor's detected data about the user.

12. The climb assist and fall arrest device of claim 11, wherein the data includes the user's speed, acceleration, or both.

13. The climb assist and fall arrest device of claim 12, wherein the at least one fall arrest component includes a threshold value for the data, and the at least one fall arrest component is configured such that when the detected data surpasses the threshold value the at least one climb assist component sends the stop signal to the motor.

14. The climb assist and fall arrest device of claim 1, wherein the at least one fall arrest component includes a braking mechanism, the at least one climb assist component includes a sensor configured to detect data, the data including an assist force exerted by the at least one climb assist component on the user.

15. The climb assist and fall arrest device of claim 14, wherein the braking mechanism includes at least one of a cam and a wheel.

16. The climb assist and fall arrest device of claim 14, wherein the at least one fall arrest component includes a threshold value for the data, and the at least one fall arrest component is configured such that when the detected data surpasses the threshold value the at least one fall arrest component activates the at least one braking mechanism to arrest motion of the user.

17. A method of providing climb assist and fall arrest to a user of a climb assist and fall arrest device, the method comprising the steps of:
coupling at least one fall arrest component to the user such that the at least one fall arrest component is configured to arrest a fall of the user;
coupling at least one climb assist component to the user such that the at least one climb assist component is configured to support at least a portion of the user's weight; and
placing the at least one fall arrest component in communication with the at least one climb assist component such that: 1) the at least one climb assist component is configured to transition from a first state to a second state in response to information sent from the at least one fall arrest component to the at least one climb assist component; 2) the at least one fall arrest component is configured to transition from a third state to a fourth state in response to information sent from the at least one climb assist component to the at least one fall arrest component; or 3) both.

18. The method of claim 17, further comprising the step of coupling the climb assist and fall arrest device to a motor such that the motor is configured to provide a force equal to at least a portion of the user's weight to the climb assist and fall arrest device.

19. The method of claim 18, further comprising the steps of:
actuating an input of the at least one climb assist component thereby transitioning the at least one climb assist component to the first state and activating the motor to provide the force to the climb assist and fall arrest device;
detecting data about the user with a sensor of the at least one fall arrest component, wherein the sent information includes the detected data, wherein the step of detecting data includes the step of detecting the user's speed, acceleration, or both;
comparing the detected data to a threshold value, determining if the detected data is greater than the threshold value, and if the detected data is greater than the threshold value transmitting the information to the at least one climb assist component; and
after the transmitting step, the step of transitioning the at least one climb assist component to the second state and deactivating the motor.

20. The method of claim 17, further comprising the step of enclosing at least a portion of the at least one fall arrest component and at least a portion of the at least one climb assist component in a housing of the climb assist and fall arrest device.
